(19) United States
(12) Patent Application Publication
(10) Pub. No.: US 2023/0219100 A1
(43) Pub. Date: Jul. 13, 2023

(54) COARSE COAL SLIME CLASSIFYING SYSTEM AND METHOD

(71) Applicant: Shaanxi Zhengtong Coal Industry Co., Ltd., Xianyang City (CN)

(72) Inventors: Jitu Yu, Xianyang City (CN); Chao Han, Xianyang City (CN); Changzeng Sheng, Xianyang City (CN); Xuexin Qu, Xianyang City (CN); Guofeng Ran, Xianyang City (CN)

(21) Appl. No.: 17/573,013

(22) Filed: Jan. 11, 2022

(51) Int. Cl. B03B 9/00; B03B 5/62; B04C 9/00; B03B 5/60; B03B 13/00

(52) U.S. Cl. CPC B03B 9/005; B03B 5/626; B04C 9/00; B03B 5/60; B03B 13/005

(57) ABSTRACT

A coarse coal slime classifying system and method are disclosed. The system includes: a coal slime bucket, an arc-shaped sieve, a hydraulic classifying cyclone, a coal slime centrifuge, and a coal slime chute. The coal slime bucket is connected to a coal slime water incoming pipe. The hydraulic classifying cyclone is connected to the arc-shaped sieve and the coal slime bucket. The arc-shaped sieve is connected to the coal slime bucket and the coal slime centrifuge. The coal slime centrifuge is connected to the coal slime chute and the coal slime bucket. The coal slime bucket, arc-shaped sieve, hydraulic classifying cyclone, coal slime centrifuge, and coal slime chute are arranged to classify coarse coal slime, which improves the product quality and the yield. The system is simple in overall structure, convenient to maintain, and low in cost.

### TECHNICAL FIELD

The present disclosure relates to the technical field of coal slime classifying equipment for coal mine, and in particular, to a coal slime classifying system and method.

### BACKGROUND

During coal washing and separation processing, coal slime recovery is an important profit source of a coal preparation plant. Coarse coal slime classification is an important phase of the coal slime recovery, wherein the recovery effect of coarse coal slime is directly related to the effect of coarse coal slime separation and fine coal slime flotation, and affects the product quality and the recovery rate. If the coarse coal slime is classified improperly, pipeline blockage would often occur, which affects normal production and operation of the coal preparation plant, and even leads to shutdown in serious cases. Therefore, a coarse slime classifying system and method are urgently needed.

### SUMMARY

In order to solve the problems in the prior art, the present disclosure provides a coarse slime classifying system and method.

In one aspect, a coal slime classifying system is provided. The system includes: a coal slime bucket, an arc-shaped sieve, a hydraulic classifying cyclone, a coal slime centrifuge, and a coal slime chute. The coal slime bucket is connected to a coal slime water incoming pipe. The hydraulic classifying cyclone is connected to the arc-shaped sieve and the coal slime bucket. The arc-shaped sieve is connected to the coal slime bucket and the coal slime centrifuge. The coal slime centrifuge is connected to the coal slime chute and the coal slime bucket.

In some embodiments, the system further may include: a closed loop control system for controlling liquid level. The closed loop control system for controlling liquid level includes: a water-filling electric valve, a liquid level indicator, and a fine control cabinet. Both the liquid level indicator and the water-filling electric valve are connected to the coal slime bucket, and are also in communication connection with the fine control cabinet.

In some embodiments, the system further may include: a closed loop control system for controlling concentration. The closed loop control system for controlling concentration includes: the water-filling electric valve, a concentration meter, and the fine control cabinet. The concentration meter is connected to the coal slime bucket, and is also in communication connection with the fine control cabinet.

In some embodiments, the system further includes: a closed loop control system for controlling pressure. The closed loop control system for controlling pressure includes: an electric valve, a pressure transmitter, and the fine control cabinet. Both the electric valve and the pressure transmitter are connected to the coal slime bucket and the hydraulic classifying cyclone. Both the electric valve and the pressure transmitter are also in communication connection with the fine control cabinet.

In some embodiments, a coal slime pump is also connected between the electric valve as well as the pressure transmitter and the coal slime bucket.

In another aspect, a coarse coal slime classifying method is provided. The method includes: collecting coal slime produced in a coal washing production process in the coal slime bucket through the coal slime water incoming pipe; pressurizing the coal slime entering the coal slime bucket through the coal slime pump and conveying the coal slime to the hydraulic classifying cyclone through a coal slime pipeline; performing accelerated sedimentation on the coal slime by using the hydraulic classifying cyclone; entering an overflow to a concentration tank through the overflow water pipe of hydraulic classifying cyclone, and an underflow to the arc-shaped sieve after the accelerated sedimentation; performing solid-liquid separation on the underflow by using the arc-shaped sieve; returning separated under-sieve water to the coal slime bucket through an under-sieve water pipeline of the arc-shaped sieve, and entering over-sieve materials to the coal slime centrifuge; centrifuging the over-sieve materials by using the coal slime centrifuge; and returning a centrifugal liquid after centrifugation to the coal slime bucket through a centrifugal liquid pipeline, and entering the discharged coal to a coal bin through the coal slime chute.

In some embodiments, the method further includes: programming to set a lower limit value of a liquid level of the coal slime bucket in the fine control cabinet; measuring the liquid level of the coal slime in the coal slime bucket in real time by using the liquid level indicator; when the liquid level of the coal slime in the coal slime bucket is lower than the lower limit value of the liquid level of the coal slime bucket, sending a first working signal to the water-filling electric valve by the fine control cabinet; after receiving the first working signal, opening the water-filling electric valve to convey water into the coal slime bucket; when the liquid level of the coal slime in the coal slime bucket reaches the lower limit value of the liquid level of the coal slime bucket, sending a second working signal to the water-filling electric valve by the fine control cabinet; and after receiving the second working signal, closing the water-filling electric valve to stop conveying water into the coal slime bucket.

In some embodiments, the method further includes: programming to set a separation pressure value in the fine control cabinet; when the coal slime in the coal slime bucket needs to be pressurized and conveyed to the hydraulic classifying cyclone through the coal slime pump, respectively sending a third working signal and a fourth working signal to the electric valve and the pressure transmitter by the fine control cabinet; after receiving the third working signal, opening the electric valve; and after receiving the fourth working signal, pressurizing and conveying the coal slime into the hydraulic classifying cyclone by the pressure transmitter according to the pressure of the separation pressure value.

In some embodiments, the method further includes: programming to set a coal slime concentration value in the fine control cabinet; measuring the concentration of the coal slime in the coal slime bucket in real time by using a concentration meter; when the coal slime concentration in the coal slime bucket is higher than the coal slime concentration value, sending a fifth working signal to the water-filling electric valve by the fine control cabinet, and filling water by the water-filling electric valve after receiving the fifth working signal; when the coal slime concentration in the coal slime bucket reaches the coal slime concentration value, sending a sixth working signal to the water-filling electric valve by the fine control cabinet, and closing the water-filling electric valve after receiving the sixth working signal; and when the coal slime concentration in the coal slime bucket is lower than the coal slime concentration value, reminding working personnel to add coal slime to the coal slime bucket through the coal slime water incoming pipe by the fine control cabinet.

The beneficial effects brought by the technical solutions provided by the embodiments of the present disclosure are that: in the present disclosure, the coal slime bucket, the arc-shaped sieve, the hydraulic grading cyclone, the coal slime centrifuge, and the coal slime chute are provided to classify coarse coal slime, which improves the product quality and the yield, and the system is simple in overall structure, convenient to maintain, and low in cost. In addition, in the present disclosure, the closed loop control system for controlling liquid level, the closed loop control system for controlling concentration, and the closed loop control system for controlling pressure are provided. The stability of the liquid level in the coal slime bucket is controlled by the closed loop control system for controlling liquid level, the stability of the coal slime concentration is controlled by the closed loop control system for controlling concentration, and the stability of the separation pressure is controlled by the closed loop control system for controlling pressure, so that the classifying effect is improved, and the classifying efficiency of the coarse coal slime is improved. In addition, automatic operation of the coarse coal slime separation can be realized, and manual intervention can be reduced; and an overflow coarsening phenomenon of the classifying cyclone can also be reduced, thus the economic benefit of the coal preparation plant can also be improved.

### BRIEF DESCRIPTION OF THE DRAWINGS

To describe the technical solutions in the embodiments of the present disclosure more clearly, the following briefly describes the accompanying drawing required for describing the embodiments. Apparently, the accompanying drawings in the following descriptions show merely some embodiments of the present disclosure, and a person of ordinary skill in the art may derive other drawings from these accompanying drawings without creative efforts.

FIG. 1 is a structural schematic diagram of a coal slime classifying system provided by the present disclosure.

Reference signs in the drawings: 1—coal slime bucket; 2—coal slime pump; 3—hydraulic classifying cyclone; 4—arc-shaped sieve; 5—coal slime centrifuge; 6—coal slime pipeline; 7—under-sieve water pipeline of the arc-shaped sieve; 8—centrifugal liquid pipeline; 9—liquid level indicator; 10—concentration meter; 11—water-filling electric valve; 12—electric valve; 13—pressure transmitter; 14—fine control cabinet; 15—control signal wire; 16—overflow water pipe of hydraulic classifying cyclone; 17—coal slime chute; and 18—coal slime water incoming pipe.

### DETAILED DESCRIPTION OF THE EMBODIMENTS

To make the objective, technical solutions, and advantages of the present disclosure clearer, implementation manners of the present disclosure will be further described in detail with reference to the accompanying drawing.

It should be noted that when a component is considered to “connect” to another component, it can be directly connected to another component or there may be intermediate components at the same time.

Unless otherwise defined, all technical and scientific terms used herein shall have the same meanings as commonly understood by those skilled in the art to which this present disclosure belongs. The terms used in specification of the present disclosure are only used to describe specific embodiments, and are not intended to limit the present disclosure.

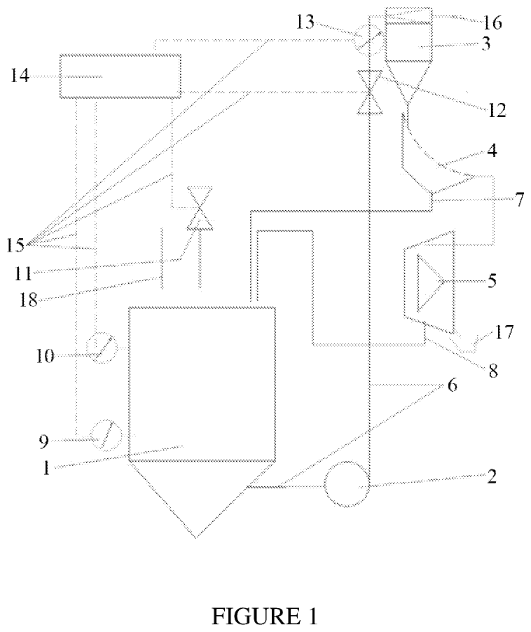

FIG. 1 is a structural schematic diagram of a coal slime classifying system provided by the present disclosure. Referring to FIG. 1, the system includes: a coal slime bucket 1, an arc-shaped sieve 4, a hydraulic classifying cyclone 3, a coal slime centrifuge 5, and a coal slime chute 17. The coal slime bucket 1 is connected to a coal slime water incoming pipe 18. The hydraulic classifying cyclone 3 is connected to the arc-shaped sieve 4 and the coal slime bucket 1. The arc-shaped sieve 4 is also connected to the coal slime bucket 1 and the coal slime centrifuge 5. The coal slime centrifuge 5 is connected to the coal slime chute 17 and the coal slime bucket 1.

It should be noted that the coal slime bucket 1 is connected to the arc-shaped sieve 4 through a under-sieve water pipeline of the arc-shaped sieve 7, so as to form a under-sieve water loop of the arc-shaped sieve, realize the secondary classification of under-sieve water, and thus prevent coarsening caused by the enlargement of sieve gaps and damage of a sieve plate. The coal slime bucket 1 is connected to the coal slime centrifuge 5 through a centrifugal liquid pipeline 8, so as to form a centrifugal liquid loop. The secondary classifying of the centrifugal liquid is realized, so as to prevent coarsening caused by the enlargement of sieve gaps and damage of a sieve basket. In addition, the coal slime bucket 1 is connected to the hydraulic classifying cyclone 3 through a coal slime pipeline 6. The system is simple in overall structure, convenient to maintain, low in cost, and convenient to transform. The classifying effect of the hydraulic classifying cyclone can be improved, and the coal slime classifying efficiency is improved. The overflow coarsening phenomenon of the classifying cyclone can be reduced, and the economic benefit of the coal preparation plant can be improved.

Further, the system further includes a closed loop control system for controlling liquid level. The closed loop control system for controlling liquid level includes a water-filling electric valve 11, a liquid level indicator 9 and a fine control cabinet 14. Both the liquid level indicator 9 and the water-filling electric valve 11 are connected to the coal slime bucket 1, and are also in communication connection with the fine control cabinet 14.

It should be noted that both the liquid level indicator 9 and the water-filling electric valve 11 are arranged on the coal slime bucket 1. The water-filling electric valve 11, the liquid level indicator 9, and the fine control cabinet 14 form the closed loop control system for controlling liquid level together, so as to achieve the stability of the liquid level of the coal slime bucket 1. In addition, both the liquid level indicator 9 and the water-filling electric valve 11 are connected to the fine control cabinet 14 through control signal wires 15 for transmitting signals.

Further, the system further includes a closed loop control system for controlling concentration. The closed loop control system for controlling concentration includes the water-filling electric valve 11, a concentration meter 10, and the fine control cabinet 14. The concentration meter 10 is connected to the coal slime bucket 1, and is also in communication connection with the fine control cabinet 14.

It should be noted that the concentration meter 10 is arranged on the coal slime bucket 1, and is configured for measuring the concentration of the coal slime in the coal slime bucket 1. The water-filling electric valve 11, the concentration meter 10, and the fine control cabinet 14 form the closed loop control system for controlling concentration together, so as to realize adjustment control of the coal slime concentration to meet the requirement on concentration of the hydraulic classifying cyclone 3. In addition, the concentration meter 10 is connected to the fine control cabinet 14 through a control signal wire 15, for transmitting signals.

Further, the system further includes a closed loop control system for controlling pressure. The closed loop control system for controlling pressure includes an electric valve 12, a pressure transmitter 13, and the fine control cabinet 14. Both the electric valve 12 and the pressure transmitter 13 are connected to the coal slime bucket 1 and the hydraulic classifying cyclone 3. Both the electric valve 12 and the pressure transmitter 13 are also in communication connection with the fine control cabinet 14.

It should be noted that both the electric valve 12 and the pressure transmitter 13 are connected to the coal slime pipeline 6. The electric valve 12, the pressure transmitter 13, and the fine control cabinet 14 form the closed loop control system for controlling pressure together, so as to meet the requirement on separation pressure of the hydraulic classifying cyclone 3. In addition, the electric valve 12 and the pressure transmitter 13 are connected to the fine control cabinet 14 through the control signal wires 15, for transmitting signals. In addition, a coal slime bucket liquid level control strategy, a separation pressure control strategy, and a coal slime concentration control strategy are programmed in the fine control cabinet 14. The fine separation control of the hydraulic classifying cyclone 3 is realized. In addition, through the improvement of the closed loop control system for controlling liquid level, the closed loop control system for controlling concentration, and the closed loop control system for controlling pressure, the automatic operation of the coarse coal slime classifying can be realized, and the product quality can also be controlled effectively, so that beneficial conditions are provided for fine coal slime flotation.

Further, a coal slime pump 2 is also connected between the electric valve 12 and the pressure transmitter 13, and the coal slime bucket 1. The coal slime pump 2 is connected to the coal slime pipeline 6, so that the coal slime in the coal slime bucket 1 can be conveyed into the hydraulic classifying cyclone 3 through the coal slime pump 2.

A coal slime classifying method provided by an embodiment of the present disclosure includes: coal slime produced in a coal washing production process is collected in the coal slime bucket 1 through the coal slime water incoming pipe 18; the coal slime entering the coal slime bucket 1 is pressurized by the coal pump 2 and conveyed to the hydraulic classifying cyclone 3 through the coal slime pipeline 6; the accelerated sedimentation on the coal slime is performed by the hydraulic classifying cyclone 3; after the accelerated sedimentation an overflow enters a concentration tank through an overflow water pipe 16 of hydraulic classifying cyclone, and an underflow enters the arc-shaped sieve 4; the solid-liquid separation on the underflow is performed by the arc-shaped sieve 4; separated under-sieve water is returned to the coal slime bucket 1 through the under-sieve water pipeline 7 of the arc-shaped sieve; over-sieve materials enters the coal slime centrifuge 5; the over-sieve materials are centrifuged by using the coal slime centrifuge 5; and after centrifugation a centrifugal liquid is returned to the coal slime bucket 1 through a centrifugal liquid pipeline 8, and the discharged coal enters a coal bin through the coal slime chute 17.

A lower limit value of a liquid level in the coal slime bucket is set by programming in the fine control cabinet 14. The liquid level indicator 9 measures the liquid level of the coal slime in the coal slime bucket 1 in real time. When the liquid level of the coal slime in the coal slime bucket 1 is lower than the lower limit value of the liquid level in the coal slime bucket, the fine control cabinet 14 sends a first working signal to the water-filling electric valve 11. The water-filling electric valve 11 is opened after receiving the first working signal, so as to convey water into the coal slime bucket 1. When the liquid level of the coal slime in the coal slime bucket 1 reaches the lower limit value of the liquid level in the coal slime bucket, the fine control cabinet 14 sends a second working signal to the water-filling electric valve 11. The water-filling electric valve 11 is closed after receiving the second working signal, so as to stop conveying water into the coal slime bucket 1.

A separation pressure value is set by programming in the fine control cabinet 14. When the coal slime in the coal slime bucket 1 needs to be pressurized and conveyed to the hydraulic classifying cyclone 3 through the coal slime pump 2, the fine control cabinet 14 sends a third working signal and a fourth working signal to the electric valve 12 and the pressure transmitter 13 respectively. The electric valve 12 is opened after receiving the third working signal. The pressure transmitter 13 pressurizes and conveys the coal slime into the hydraulic classifying cyclone 3 according to the pressure of the separation pressure value after receiving the fourth working signal.

A coal slime concentration value is set by programming in the fine control cabinet 14. The concentration meter 10 measures the concentration of the coal slime in the coal slime bucket 1 in real time. When the coal slime concentration in the coal slime bucket 1 is higher than the coal slime concentration value, the fine control cabinet 14 sends a fifth working signal to the water-filling electric valve 11. The water-filling electric valve 11 fills water after receiving the fifth working signal. When the coal slime concentration in the coal slime bucket 1 reaches the coal slime concentration value, the fine control cabinet 14 sends a sixth working signal to the water-filling electric valve 11. The water-filling electric valve 11 is closed after receiving the sixth working signal. When the coal slime concentration in the coal slime bucket 1 is lower than the coal slime concentration value, the fine control cabinet 14 reminds working personnel to add coal slime to the coal slime bucket 1 through the coal slime water incoming pipe 18.

It should be noted that an alarm device may be provided in the fine control cabinet 14. When the concentration of the coal slime in the coal slime bucket 1 is lower than the coal slime concentration value, the concentration meter 10 sends data to the fine control cabinet 14. After the fine control cabinet 14 receives data, an alarm signal is sent to the alarm device. The alarm device gives an alarm after receiving the alarm signal, so as to remind the working personnel that the coal slime concentration value is lower than the preset coal slime concentration value, and the coal slime needs to be added to increase the coal slime concentration.

It is worth noting that, in the present disclosure, the coal slime bucket, the arc-shaped sieve, the hydraulic classifying cyclone, the coal slime centrifuge, and the coal slime chute are provided to classify coarse coal slime, which improves the product quality and the yield, and the system is simple in overall structure, convenient to maintain, and low in cost. In addition, in the present disclosure, the closed loop control system for controlling liquid level, the closed loop control system for controlling concentration, and the closed loop control system for controlling pressure are also provided. The stability of the liquid level in the coal slime bucket is controlled by the closed loop control system for controlling liquid level, the stability of the coal slime concentration is controlled by the closed loop control system for controlling concentration, and the stability of the separation pressure is controlled by the closed loop control system for controlling pressure, so that the classifying effect is improved, and the classifying efficiency of the coarse coal slime is improved. In addition, automatic operation of the coarse coal slime can be realized, and manual intervention can be reduced; and an overflow coarsening phenomenon of a classifying cyclone can also be reduced, and the economic benefit of the coal preparation plant can also be improved.

The above mentioned sequence numbers of the embodiments of the present disclosure are merely for purpose of description, and do not represent the advantages and disadvantages of the embodiments.

The above is merely preferred embodiments of the present disclosure and is not intended to limit the present disclosure. Any modifications, equivalent replacements, improvements and the like made within the spirit and principle of the present disclosure shall fall within the scope of protection of the present disclosure.

What is claimed is:

1. A coal slime classifying system, comprising:
a coal slime bucket, an arc-shaped sieve, a hydraulic classifying cyclone, a coal slime centrifuge, and a coal slime chute,
wherein the coal slime bucket is connected to a coal slime water incoming pipe;
the hydraulic classifying cyclone is connected to the arc-shaped sieve and the coal slime bucket;
the arc-shaped sieve is connected to the coal slime bucket and the coal slime centrifuge; and the coal slime centrifuge is connected to the coal slime chute and the coal slime bucket.

2. The coal slime classifying system according to claim 1, further comprising:
a closed loop control system for controlling liquid level, wherein
the closed loop control system for controlling liquid level comprises a water-filling electric valve, a liquid level indicator, and a fine control cabinet;
both the liquid level indicator and the water-filling electric valve are connected to the coal slime bucket, and are in communication connection with the fine control cabinet.

3. The coal slime classifying system according to claim 2, further comprising:
a closed loop control system for controlling concentration, wherein
the closed loop control system for controlling concentration comprises the water-filling electric valve, a concentration meter, and the fine control cabinet; and
the concentration meter is connected to the coal slime bucket, and is also in communication connection with the fine control cabinet.

4. The coal slime classifying system according to claim 3, further comprising:
a closed loop control system for controlling pressure, wherein
the closed loop control system for controlling pressure comprises an electric valve, a pressure transmitter, and the fine control cabinet; both the electric valve and the pressure transmitter are connected to the coal slime bucket and the hydraulic classifying cyclone; and
both the electric valve and the pressure transmitter are in communication connection with the fine control cabinet.

5. The coal slime classifying system according to claim 4, wherein a coal slime pump is connected between the electric valve as well as the pressure transmitter and the coal slime bucket.

6. A coarse coal slime classifying method, applied to a coal slime classifying system, wherein, the coal slime classifying system comprises a coal slime bucket, an arc-shaped sieve, a hydraulic classifying cyclone, a coal slime centrifuge, and a coal slime chute,
wherein the coal slime bucket is connected to a coal slime water incoming pipe;
the hydraulic classifying cyclone is connected to the arc-shaped sieve and the coal slime bucket;
the arc-shaped sieve is connected to the coal slime bucket and the coal slime centrifuge; and the coal slime centrifuge is connected to the coal slime chute and the coal slime bucket; and
wherein a coal slime pump is connected between the electric valve as well as the pressure transmitter and the coal slime bucket;
the method comprising:
collecting coal slime produced in a coal washing production process in the coal slime bucket through the coal slime water incoming pipe;
pressurizing the coal slime in the coal slime bucket by the coal slime pump, and conveying the coal slime to the hydraulic classifying cyclone through a coal slime pipeline;
performing accelerated sedimentation on the coal slime by the hydraulic classifying cyclone; after the accelerated sedimentation, entering an overflow to a concentration tank through the hydraulic classifying cyclone overflow water pipe, and an underflow to the arc-shaped sieve;
performing solid-liquid separation on the underflow by the arc-shaped sieve;
returning separated under-sieve water to the coal slime bucket through an under-sieve water pipeline of the arc-shaped sieve, and entering over-sieve materials to the coal slime centrifuge;
centrifuging the over-sieve materials by the coal slime centrifuge; and
returning a centrifuged centrifugal liquid after centrifugation to the coal slime bucket through a centrifugal liquid pipeline, and entering a discharged coal to a coal bin through the coal slime chute.

7. The method according to claim 6, further comprising:
programming to set a lower limit value of a liquid level in the coal slime bucket in the fine control cabinet;
measuring the liquid level of the coal slime in the coal slime bucket in real time by the liquid level indicator;
when the liquid level of the coal slime in the coal slime bucket is lower than the lower limit value of the liquid level in the coal slime bucket, sending a first working signal to the water-filling electric valve by the fine control cabinet;
after receiving the first working signal, opening the water-filling electric valve to convey water into the coal slime bucket;
when the liquid level of the coal slime in the coal slime bucket reaches the lower limit value of the liquid level in the coal slime bucket, sending a second working signal to the water-filling electric valve by the fine control cabinet;
and after receiving the second working signal, closing the water-filling electric valve to stop conveying water into the coal slime bucket.

8. The method according to claim 7, further comprising:
programming to set a separation pressure value in the fine control cabinet;
sending a third working signal and a fourth working signal to the electric valve and the pressure transmitter respectively by the fine control cabinet when the coal slime in the coal slime bucket is pressurized and conveyed to the hydraulic classifying cyclone by the coal slime pump; after receiving the third working signal, opening the electric valve; and
after receiving the fourth working signal, pressurizing and conveying the coal slime into the hydraulic classifying cyclone by the pressure transmitter according to a pressure of the separation pressure value.

9. The method according to claim 8, further comprising:
programming to set a coal slime concentration value in the fine control cabinet;
measuring the concentration of the coal slime in the coal slime bucket by a concentration meter;
sending a fifth working signal to the water-filling electric valve by the fine control cabinet when the coal slime concentration in the coal slime bucket is higher than the coal slime concentration value predetermined, and filling water by the water-filling electric valve after receiving the fifth working signal; sending a sixth working signal to the water-filling electric valve by the fine control cabinet when the coal slime concentration in the coal slime bucket reaches the coal slime concentration value predetermined, and closing the water-filling electric valve after receiving the sixth working signal; and
reminding working personnel by the fine control cabinet to add the coal slime to the coal slime bucket through the coal slime water incoming pipe when the coal slime concentration in the coal slime bucket is lower than the coal slime concentration value predetermined.
